(19) United States
(12) Patent Application Publication
(10) Pub. No.: US 2026/0116338 A1
(43) Pub. Date: Apr. 30, 2026

(54) METHOD FOR OPERATING AN ANTI-THEFT ALARM SYSTEM FOR A VEHICLE

(71) Applicant: HELLA GMBH & CO. KGAA, Lippstadt (DE)

(72) Inventors: Roman Curkin, Lippstadt (DE); Oliver Kirsch, Wuppertal (DE); Ludger Weghaus, Lippstadt (DE)

(21) Appl. No.: 19/372,518

(22) Filed: Oct. 29, 2025

(30) Foreign Application Priority Data
Oct. 29, 2024 (DE) 102024131540.7

(51) Int. Cl. B60R 25/10; B60R 25/31

(52) U.S. Cl. CPC B60R 25/1004; B60R 25/31

(57) ABSTRACT

The invention relates to a method for operating an anti-theft alarm system for a vehicle, including at least one sensor device for monitoring a vehicle interior of the vehicle as well as at least one alarm. The method includes transmission of an electromagnetic output signal by the sensor device, reception of an impulse response to the output signal by the sensor device, the impulse response including a plurality of runtime components, each runtime component being characteristic of a specific signal runtime, comparison of the impulse response with a reference impulse response and determination of changes of the runtime components relative to the reference impulse response, determination of a change value as a function of the changes in at least a portion of the runtime components, and activation of at least one alarm when the change value reaches or exceeds a predetermined change reference value.

### CROSS-REFERENCE TO RELATED APPLICATIONS

The present application claims the benefit of German Patent Application DE 10-2024-131-540.7, filed Oct. 29, 2024, the disclosure of which is incorporated by reference.

### FIELD OF THE INVENTION

The invention relates to a method for operating an anti-theft alarm system for a vehicle, an anti-theft alarm system for a vehicle, a vehicle with an anti-theft alarm system, a computer program product, a computer-readable storage medium, as well as a data carrier signal.

### BACKGROUND OF THE INVENTION

It is known that anti-theft alarm systems are used in vehicles. These monitor the interior of the vehicle when it is parked or alternatively stopped and detect unauthorized access to the vehicle interior or alternatively trigger an alarm in this case. Anti-theft alarm systems typically use ultrasonic sensors, which are provided solely for monitoring the vehicle interior and are not used for other vehicle functions. The integration of such an anti-theft alarm system into a vehicle is disadvantageous in terms of the manufacturing costs of the vehicle. With regard to anti-theft alarm systems, it is also known that they can tend to trigger false alarms, which limits the ease of use of the vehicle.

### SUMMARY OF THE INVENTION

It is therefore one task of the present invention to at least partially overcome at least one of the aforementioned disadvantages. In particular, the task of the invention is to provide a method for operating an anti-theft alarm system for a vehicle, an anti-theft alarm system for a vehicle, a vehicle with an anti-theft alarm system, a computer program product, a computer-readable storage medium, as well as a data carrier signal, which enable the more cost-effective implementation of an anti-theft alarm system in a vehicle, and/or to efficiently avoid false alarms of an anti-theft alarm system.

The above task is solved by a method for operating an anti-theft alarm system for a vehicle according to a first aspect of the present invention, by an anti-theft alarm system for a vehicle according to a second aspect of the present invention, by a vehicle with an anti-theft alarm system according to a third aspect of the present invention, by a computer program product according to a fourth aspect of the present invention, by a computer-readable storage medium according to a fifth aspect of the present invention, as well as by a data carrier signal according to a sixth aspect of the present invention. Further features and details of the invention are apparent from the subclaims, the description, and the drawings. Features and details described in connection with the carrier module according to the invention also apply, of course, in connection with the carrier device according to the invention and/or in connection with the carrier system according to the invention and/or in connection with the method according to the invention, and vice versa, so that mutual reference is or alternatively can be made to the disclosure of the individual aspects of the invention.

According to a first aspect, the present invention relates to a method for operating an anti-theft alarm system for a vehicle, comprising at least one sensor device for monitoring a vehicle interior of the vehicle as well as at least one alarm, wherein the method comprises: transmission of an electromagnetic output signal by the sensor device; reception of an impulse response to the output signal by the sensor device, wherein the impulse response comprises a plurality of runtime components, wherein each runtime component is characteristic of a specific signal runtime; comparison of the impulse response with a reference impulse response and determination of changes in the runtime components relative to the reference impulse response, in particular by the sensor device and/or a control unit; determination of a change value as a function of the changes in at least a portion of the runtime components, in particular by aggregating the changes in at least a portion of the runtime components, in particular by the sensor device and/or a control unit; and activation of at least one alarm when the change value reaches or exceeds a predetermined change reference value, in particular by the sensor device and/or a control unit.

It can be provided in the context of the invention that the method is a computer-implemented method. In addition or alternatively, it is conceivable that at least individual steps of the method, at least in part, run simultaneously or that the steps of the method are carried out in the specified order. In addition or alternatively, at least individual steps of the method or all steps of the method may be performed in a recurring manner. In particular, each transmission of an electromagnetic output signal may initiate a renewed execution of the entire method.

In other words, the present invention proposes a method for operating an anti-theft alarm system, wherein the anti-theft alarm system comprises at least one sensor device for monitoring a vehicle interior of the vehicle.

According to the invention, it is provided that an electromagnetic output signal is put out by the sensor device. This output signal is reflected, at least in part, by objects in the interior of the vehicle or in the external vehicle environment. The reflected signals are received by the sensor device as an impulse response to the output signal.

In so doing, the channel impulse response (CIR) comprises a plurality of runtime components (taps). The runtime components should be understood as signal components of the impulse response that were received in time-delayed manner by the sensor device. This time delay results in particular from the sampling rate at which incoming signals, especially wave signals, are sampled by the sensor device. Different runtime components correspond, for example, to reflections of the output signal from objects that are at different distances from the sensor device. Each of the runtime components is therefore specific to a signal runtime. Assuming that the electromagnetic output signal propagates at the speed of light, each signal runtime or alternatively runtime component is also characteristic of a distance between the sensor device and the object that reflected the output signal.

It is, moreover, provided according to the invention that, in particular by means of the sensor device and/or a control unit, the impulse response is compared with a reference impulse response and changes in the impulse response, in particular changes in the amplitude of the impulse response, relative to the reference impulse response, in particular relative to the amplitude of the reference impulse response, are determined for the respective runtime components. The reference impulse response characterizes a reference state in which there is no unauthorized access to the vehicle interior. Deviations of the impulse response from the reference impulse response allow the conclusion to be drawn that an unauthorized access to the vehicle is taking place. In so doing, the changes are preferably determined specifically for each runtime component.

A reference impulse response can, for example, be predetermined for a specific vehicle or alternatively a specific sensor device, in particular at the factory, or alternatively be stored in a data memory of the sensor device and/or a control unit. A reference impulse response can comprise a number of runtime components corresponding to the impulse response, each of which is characteristic of the same signal runtimes of the runtime components of the impulse response.

It is, moreover, provided that, in particular by means of the sensor device and/or a control unit, a change value is determined as a function of the changes of at least a portion of the respective runtime components, in particular all of them, in particular those comprised by the impulse response. In particular, the changes of all runtime components or only a portion of the runtime components can be used for this purpose. Preferably, for this purpose, the changes of the individual runtime components can be aggregated to form a change value or alternatively total change value.

It is, moreover, provided that the determined change value is compared with a predetermined change reference value and at least one alarm means is activated when the change value reaches or exceeds the change reference value. In other words, an alarm means is activated when the change in the impulse response reaches or alternatively exceeds a predefined limit value (change reference value).

In the context of the invention, it may be provided that the at least one alarm means is only activated when the change value reaches or exceeds the change reference value in at least two, in particular chronologically successive, received impulse responses. In other words, it may be provided that the method is performed with respect to several chronologically successive impulse responses and that the at least one alarm means is only activated when the change value reaches or exceeds the change limit value in a plurality of impulse responses, in particular at least two or at least four or at least 10. In so doing, the mechanisms described in the context of the invention may preferably be applied with regard to the processing of each impulse response.

The method according to the invention provides that at least one electromagnetic sensor is used for interior monitoring. In contrast to the use of ultrasonic sensors, this enables the sensor devices required for the anti-theft alarm system to also be used for other vehicle systems, such as, in particular, systems for access control or alternatively usage control in the vehicle. The number of sensors that are to be provided in a vehicle can hereby be reduced and a simpler and more cost-effective vehicle design can be realized. In the context of the method, it is, moreover, provided that a triggering of the alarm only occurs when the change value exceeds a predetermined limit value, whereby the triggering of false alarms can be prevented.

In particular, at least one sensor device can be configured to transmit an electromagnetic output signal and to receive an impulse response to the output signal.

Changes in runtime components can preferably be considered in terms of magnitude in order to detect signal changes regardless of their direction.

In the context of the invention, it may, moreover, be provided that the determination of the change value comprises the following: neglecting the runtime components within a predetermined signal runtime range, wherein the signal runtime range characterizes a close-up detection range of the sensor device.

In other words, it may be provided that, when determining the change value, those runtime components that are comprised in the signal runtime range, in particular when aggregating the changes of the runtime components of the impulse response, are not taken into account and, in particular, the remaining runtime components are taken into account.

It has proven advantageous in the context of the invention that at least one sensor device is arranged in or alternatively on a headliner of the vehicle interior. Such an arrangement offers the advantage that the sensor device cannot be accidentally covered by objects placed in the vehicle interior. In this regard, it has been shown that when roof materials that are permeable to electromagnetic radiation (for example, glass or plastic) are used in the area of the sensor device, the sensor device is sensitive to objects in the external environment of the vehicle. In this case, an anti-theft alarm system may be prone to false alarms when rain falls on the vehicle roof or, for example, a user places an arm on the vehicle roof in the area of the sensor device. Such a false alarm can be prevented by neglecting the runtime components within the signal runtime range. Objects that trigger a false alarm in the manner described above are located relatively close to the sensor device, which is to say, within the close-up detection range of the sensor device. The neglect of the runtime components corresponding to the close-up detection range concentrates the sensitivity of the sensor device on more distant objects, thereby avoiding false alarms due to influences from the external vehicle environment while still allowing the reliable detection of unauthorized intrusion into the vehicle.

A close-up detection range of the sensor device should be understood as a detection range that extends from the sensor device and is smaller than a total detection range extending from the sensor device. In particular, the close-up detection range can characterize an area of up to 40 cm around the sensor device, in particular up to 30 cm around the sensor device, preferably less than 30 cm around the sensor device. In addition or alternatively, the close-up detection range can characterize an area of a maximum of 30%, preferably a maximum of 20%, of a total detection range of the sensor device. The signal runtime range thus comprises signal runtimes that correspond to the distances mentioned. The signal runtime range can be individually defined depending on the vehicle type and the arrangement of the sensor devices within the vehicle.

In particular, the signal runtime range comprises at least one runtime component, preferably a plurality of runtime components. The runtime components comprised by the signal runtime range can preferably form a contiguous range of runtime components.

In relation to the present invention, it may advantageously be provided that the following is comprised: determination of a partial change value for a predetermined signal runtime range, in particular by aggregating the changes of the runtime components within the signal runtime range, wherein the signal runtime range characterizes a close-up detection range of the sensor device, in particular by the sensor device and/or a control unit; comparison of the partial change value with a predetermined partial change limit value and, in particular, providing a comparison result; and adjustment of the operation, in particular as regards sensitivity, of the anti-theft alarm system as a function of the comparison result, in particular by the sensor device and/or a control unit.

The partial change value thus represents only the change in the impulse response relative to the reference impulse response for the subset of runtime components comprised in the signal runtime range. By the determination of the partial change value or alternatively its comparison with a partial change limit value, it is thus possible to draw conclusions about the extent of the changes in the impulse response relative to the reference impulse response in the close-up detection range of the sensor device. If the change in the impulse response or alternatively the changes in the respective runtime components in the signal runtime range exceed a predetermined level, the operation of the anti-theft alarm system can be adjusted to avoid false alarms. This has proven to be particularly effective in avoiding false alarms caused by objects or influences from the external vehicle environment.

It may, in particular, be provided that the adjustment of the operation of the anti-theft alarm system comprises the following: adjustment of the change reference value in such a way that a sensitivity of the anti-theft alarm system is reduced when the partial change value reaches or exceeds the partial change limit value, in particular by means of the sensor device and/or a control unit.

In this way, in the case of an increased activity in the close-up detection range of the sensor device, the overall sensitivity of the anti-theft alarm system can be reduced, thereby preventing false alarms. In particular, the change reference value can be raised in order to reduce the overall sensitivity of the anti-theft alarm system.

In particular, reducing sensitivity should be understood here as adjusting the anti-theft alarm system in such a way that stronger activity in the vehicle interior must be detected or alternatively stronger changes in the impulse responses are required in order to trigger an alarm.

In addition or alternatively, with regard to the present invention, it may be provided that the adjustment of the operation of the anti-theft alarm system comprises the following: neglecting at least a portion of the runtime components within the predetermined signal runtime range during the determination of the change value when the partial change value reaches or exceeds a predetermined partial change limit value, in particular by the sensor device and/or a control unit.

Such an approach has proven to be advantageous, since the runtime components within the signal runtime range are not neglected across the board, but only when comparatively large changes in the impulse response occur within this signal runtime range or alternatively in the close-up detection range. In this way, the highest possible sensitivity of the anti-theft alarm system can be maintained.

With regard to the present invention, it is, moreover, conceivable that the adjustment of the operation of the anti-theft alarm system comprises: reduction of a weighting of at least one runtime component within the predetermined signal runtime range during the determination of the change value when the partial change value reaches or exceeds a predetermined partial change limit value, in particular by the sensor device and/or a control unit.

It may, in particular, be provided that the runtime components are weighted with a weighting factor less than 1, wherein those runtime components outside the signal runtime range are weighted with a weighting factor of 1. In an equivalent manner, the weighting of the runtime components outside the signal runtime range can also be increased and the weighting of the runtime components within the signal runtime range can be left unchanged. In this case, an additional adjustment of the change limit value may be useful.

It may be provided that, when weighting the runtime components within the predetermined signal runtime range, only a constant weighting factor is applied to all affected runtime components. Alternatively, it may be provided that specific weighting factors are applied to at least individual runtime components, wherein the specific weighting factors may differ at least in part.

Such specific weighting factors can be predetermined at the factory and adapted to the respective vehicle configuration or alternatively to the configuration of the anti-theft alarm system. Individual runtime components may be susceptible to comparatively significant changes. This behavior can be taken into account by an individual adjustment of the weighting factors. It may be provided that a weighting factor or alternatively specific weighting factors for different runtime components are stored in a data memory of a sensor device or alternatively a control unit.

In addition or alternatively, it may be provided that the determination of changes in the runtime components comprises: filtering of the changes in the runtime components, in particular by means of a high-pass filter, in particular by the sensor device and/or a control unit. Interference effects or alternatively noise effects can hereby be removed and a higher-quality signal can be provided.

It may preferably be provided that the reception of an impulse response comprises a demodulation and/or sampling of at least one wave signal arriving at the sensor device. It may preferably be provided that the sampling of a wave signal takes place with a frequency of between 0.5 GHz and 2 GHz, particularly preferably with a frequency of 1 GHz.

Each sampling thereby corresponds to a runtime component in the impulse response. If a sampling is performed at 1 GHz, which is to say, at time intervals of 1 ns, neighboring runtime components are spaced apart by a runtime difference of 1 ns. Assuming that electromagnetic waves propagate at the speed of light, which can be approximated as 300,000,000 m/s, this runtime difference can be converted into a distance to the object by which the output signal was reflected. A runtime of 1 ns corresponds to a run length of the signal of 30 cm. Due to the distance traveled by the signal to the object and the return path of the reflected signal to the sensor device, this corresponds to a distance of 15 cm between the object and the sensor device.

According to a second aspect, the present invention relates to an anti-theft alarm system for a vehicle, comprising at least one sensor device for monitoring a vehicle interior of the vehicle, wherein the anti-theft alarm system is formed to be operated according to a method according to the first aspect of the present invention. In this respect, the anti-theft alarm system offers the same advantages as those already described in relation to a method according to the first aspect of the present invention.

In the context of the invention, it may be provided that the anti-theft alarm system comprises a plurality of sensor devices for monitoring the vehicle interior of the vehicle. In particular, at least two, at least three, at least four, or more than four sensor devices may be provided.

A preferred further development of the present invention may consist in at least one sensor device being formed as a UWB sensor (UWB, ultra-wideband) or alternatively comprising at least one UWB sensor. The advantage that the function of the anti-theft alarm system can be implemented by means of sensors which are already present in a plurality of vehicles or alternatively can be used for other vehicle applications is hereby achieved. In this manner, UWB sensors are used in particular to locate a key or another ID provider, such as a mobile phone, in the interior of the vehicle in order to implement access control or alternatively usage control, in particular a keyless go system, in the vehicle. Such a vehicle system can be correspondingly implemented making use of the sensor devices provided in the anti-theft alarm system. The overall sensor technology required for a vehicle can thus be reduced, which decreases the complexity of the vehicle as well as the manufacturing costs.

For the transmission of an electromagnetic output signal and/or for the reception of an impulse response to the electromagnetic output signal, it may be provided that at least one sensor device comprises at least one antenna. It may be provided that at least two separate antennas are formed or alternatively used for transmission and reception. Alternatively, it may be provided that both transmission and reception are carried out by means of only one antenna.

In the context of the invention, it may, moreover, be provided that at least one sensor device is formed to transmit the electromagnetic output signal in a recurring manner, in particular at equidistant time intervals, or alternatively that the output signal is transmitted in a recurring manner, in particular at equidistant time intervals. In particular, the electromagnetic output signal may be transmitted, for example, with a frequency between 1 Hz and 50 Hz, in particular with a frequency between 5 Hz and 25 Hz, preferably with a frequency of at least or precisely 10 Hz. In a manner corresponding to the temporally recurring transmission of the output signal, the reception of impulse responses may also occur in a temporally recurring manner.

At least one anti-theft alarm system may preferably comprise at least one control unit. The control unit may preferably be configured to control, at least in part, the execution of a method according to the first aspect of the present invention.

At least one control unit and/or sensor device may comprise means for data processing. In particular, the means for data processing may comprise at least one processor and/or at least one working memory and/or at least one, in particular non-volatile, data memory.

At least one control unit may preferably, at least temporarily, be in signal communication with at least one sensor device and/or at least one alarm means or alternatively be capable of being brought into such communication. In this manner, for example, signals of the sensor device can be transmitted to the control unit, be processed by the control unit, and, if necessary, an alarm means can be activated by the control unit. The processes described can also be implemented directly by a sensor device. Alternatively, it may be provided that at least one control unit is integrated into a sensor device or alternatively is comprised therein.

According to a third aspect, the present invention relates to a vehicle comprising an anti-theft alarm system comprising at least one sensor device for monitoring a vehicle interior of the vehicle, wherein the sensor device is configured to transmit an electromagnetic output signal and to receive an impulse response to the output signal. In particular, at least one sensor device of the anti-theft alarm system may be formed as a UWB sensor. In addition or alternatively, it may be provided that at least one sensor device of the anti-theft alarm system may be provided for the implementation of a vehicle system for access control or usage control, in particular a keyless go system, in the vehicle. Through the use of electromagnetic sensors, the integration of an anti-theft alarm system into a vehicle can be implemented more cost-effectively and efficiently, inasmuch as the use of dedicated sensor devices can be avoided. The vehicle may preferably be formed as a car or alternatively as a passenger car or as a commercial vehicle, in particular as a truck.

A preferred further development of the invention may consist in that at least one sensor device is electromagnetically shielded in the direction of an external environment of the vehicle, at least in part, by at least one shielding element. The advantage whereby false alarms due to objects or influences from the external vehicle environment can be prevented can hereby be implemented.

At least one shielding element may preferably be formed as a metallic shielding element, in particular a metal sheet or alternatively a metal plate. It may hereby be ensured that the electromagnetic output signals emitted by the sensor device do not propagate into the external environment of the vehicle and cannot be reflected there. Changes in the impulse response due to objects in the external vehicle environment, such as a hand placed on the vehicle roof, or environmental influences, such as heavy rain, can be prevented or alternatively reduced in this way.

In addition or alternatively, at least one shielding element can be formed as a damping element, in particular an anti-vibration mat, wherein the damping element has a damping effect for electromagnetic radiation in a predetermined frequency range. The frequency range can preferably comprise frequencies of between 6 and 10 GHz.

In addition or alternatively, in the context of the invention, it may preferably be provided that at least one anti-theft alarm system of a vehicle is formed as an anti-theft alarm system according to the second aspect of the present invention. False alarms can hereby be effectively avoided even without the use of shielding elements. This results in the same advantages as those described in relation to a method according to the first aspect of the invention and/or an anti-theft alarm system according to the second aspect of the present invention. An additional use of shielding elements is conceivable.

It is, moreover, preferably conceivable that at least one sensor device of the anti-theft alarm system is arranged in or alternatively on a headliner of the vehicle. This results in the advantage that the sensor device cannot be accidentally covered by objects placed in the vehicle interior.

In the context of the invention, it may preferably be provided that an anti-theft alarm system and/or a vehicle comprises at least one alarm means. At least one alarm means may be formed as a visual alarm means or alternatively for the issuance of a visual alarm signal. A visual alarm means may, for example, be formed as a light source of the vehicle, in particular as a headlight, a turn signal, a taillight, interior lighting, or the like. The activation of an alarm means, in particular a visual alarm means, may, for example, comprise the activation of a hazard warning light system of the vehicle. In addition or alternatively, in the context of the invention, at least one alarm means may be formed as an acoustic alarm means or alternatively for the issuance of an acoustic warning signal. An acoustic alarm means may, for example, be formed as a horn of the vehicle or as a loudspeaker for emitting an acoustic warning signal.

According to a fourth aspect, the present invention relates to a computer program product, wherein the computer program product comprises commands that cause an anti-theft alarm system according to the second aspect of the present invention to execute a method according to the first aspect of the present invention. In this respect, the computer program product according to the invention offers the same advantages as those described in relation to the method according to the invention and/or to the anti-theft alarm system according to the invention and/or to the vehicle according to the invention.

According to a fifth aspect, the present invention relates to a computer-readable storage medium, wherein a computer program product according to the fourth aspect of the present invention is stored on the computer-readable storage medium. In this respect, the computer-readable storage medium according to the invention offers the same advantages as those described in relation to a method according to the invention and/or to an anti-theft alarm system according to the invention and/or to a vehicle according to the invention and/or to a computer program product according to the invention.

According to a sixth aspect, the present invention relates to a data carrier signal, wherein the data carrier signal transmits a computer program product according to the fourth aspect of the present invention. In this respect, the data carrier signal according to the invention offers the same advantages as those described in relation to a method according to the invention and/or to an anti-theft alarm system according to the invention and/or to a vehicle according to the invention and/or to a computer program product according to the invention and/or to a computer-readable storage medium according to the invention.

Further advantages, features, and details of the invention are apparent from the following description, in which several embodiment examples of the invention are described in detail with reference to the drawings. The features mentioned in the claims and in the description may thereby be essential to the invention individually or in any combination.

### BRIEF DESCRIPTION OF THE DRAWINGS

The invention is elucidated in more detail below with reference to the accompanying drawings. Wherein:

FIG. 1 shows a schematic view of a method;

FIG. 2 shows a schematic view of an anti-theft alarm system;

FIG. 3 shows a schematic view of a vehicle;

FIG. 4 shows a schematic view of changes in impulse responses over time; and

FIG. 5 shows a schematic view of a runtime component over time.

### DETAILED DESCRIPTION OF THE CURRENT EMBODIMENTS

In the figures, identical reference symbols are used for the same technical features, even in different embodiment examples.

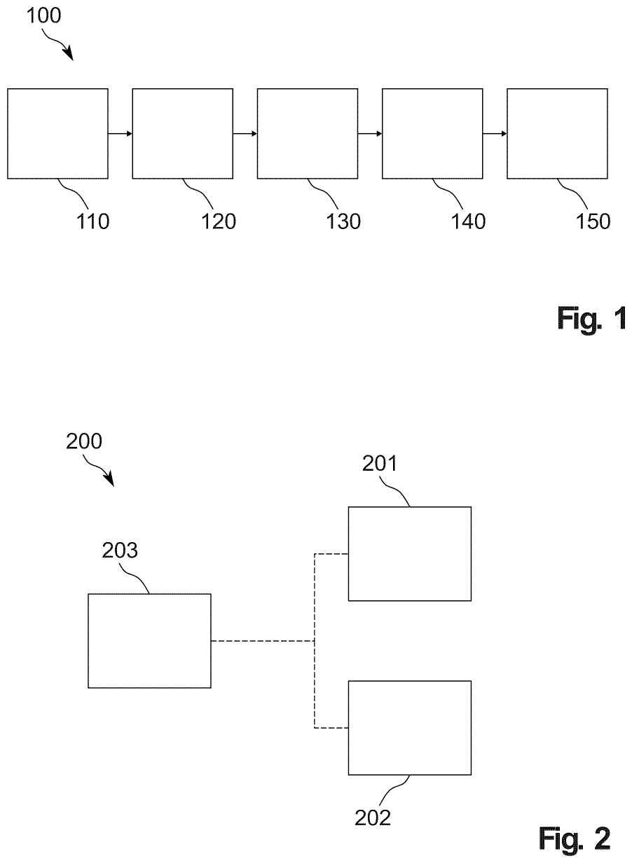

FIG. 1 shows a schematic view of a method 100 for operating an anti-theft alarm system 200 for a vehicle 300, comprising at least one sensor device 201 for monitoring a vehicle interior 301 of the vehicle 300 as well as at least one alarm means 202, wherein the method 100 comprises: transmission 110 of an electromagnetic output signal by the sensor device 201; reception 120 of an impulse response to the output signal by the sensor device 201, wherein the impulse response comprises a plurality of runtime components LK, wherein each runtime component LK is characteristic of a specific signal runtime; comparison 130 of the impulse response with a reference impulse response and determination of changes D of the runtime component LK relative to the reference impulse response; determination 140 of a change value as a function of the changes in at least a portion of the runtime component LK, in particular by aggregating the changes in at least a portion of the runtime component LK; and activation 150 of at least one alarm means when the change value reaches or exceeds a predetermined change reference value.

FIG. 2, moreover, shows a schematic view of an anti-theft alarm system 200 for a vehicle 300, comprising at least one sensor device 201 for monitoring a vehicle interior 301 of the vehicle 300. The anti-theft alarm system 200 is formed to be operated according to a method 100 according to the first aspect of the present invention.

The anti-theft alarm system moreover comprises a control unit 203 for controlling the anti-theft alarm system 200 as well as an alarm means 202 that can be activated or alternatively deactivated by the control unit 203. Alternatively or additionally, at least one alarm means 202 can also be implemented on the vehicle side.

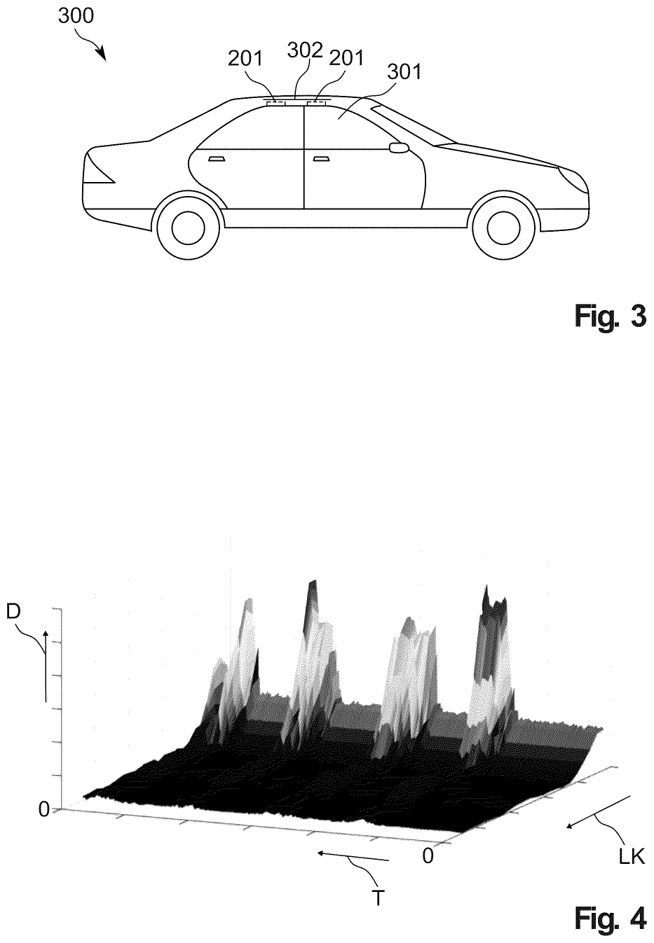

FIG. 3, moreover, shows a schematic view of a vehicle 300 comprising an anti-theft alarm system 200. Two sensor devices 201 of the anti-theft alarm system 200 are shown here for monitoring a vehicle interior 301 of the vehicle 300. The sensor devices 201 are arranged in or alternatively on a headliner of the vehicle 300. The sensor devices 201 are, moreover, each shielded from an external environment of the vehicle 300, at least in part, by at least one shielding element 302.

FIG. 4 shows a schematic view of a series of changes D in impulse responses relative to a reference impulse response, plotted over time T, wherein the impulse responses were received by a sensor device 201 in response to electromagnetic output signals transmitted in temporal succession.

It is evident that each of the impulse responses comprises a plurality of runtime components LK, whose respective changes together form the change of the entire impulse response.

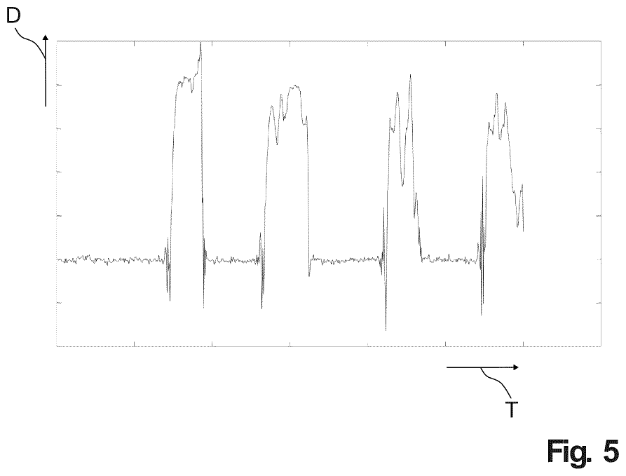

FIG. 5, moreover, shows the course of the change of a runtime component LK across a plurality of impulse responses. FIG. 5 thus represents a section through FIG. 5 at a specific runtime component LK, wherein the section plane is spanned by time T as well as change D and runs along a constant runtime component LK.

It is evident that the runtime component LK shown in FIG. 5 changes significantly over time T compared to a reference impulse response. A comparatively large change D of this runtime component LK indicates, for example, an arm on the vehicle roof near the sensor device. In such a situation, no alarm should be triggered by the anti-theft alarm system 200, inasmuch as no activity is taking place in the vehicle interior 301.

If such behavior is detected for one or a plurality of runtime components LK, especially in a close-up detection range of a sensor device, and the respective changes D exceed a change limit value, the behavior of the anti-theft alarm system can be adjusted in the manner described. Alternatively or additionally, at least individual runtime components LK that react very sensitively to influences of this kind can be neglected from the outset.

The preceding description of the embodiments describes the present invention exclusively in the context of examples. Of course, individual features of the embodiments can be freely combined with each other, provided that this is technically sensible, without departing from the scope of the present invention.

### LIST OF REFERENCE NUMBERS

100 Method
110 Transmission
120 Reception
130 Comparison
140 Determination
150 Activation
200 Anti-theft alarm system
201 Sensor device
202 Alarm means
203 Control unit
300 Vehicle
301 Vehicle interior
302 Shielding element
LK Runtime component
D Change
T Time

The above description is that of a current embodiment of the invention. Various alterations and changes can be made without departing from the spirit and broader aspects of the invention. This disclosure is presented for illustrative purposes and should not be interpreted as an exhaustive description of all embodiments of the invention or to limit the scope of the claims to the specific elements illustrated or described in connection with these embodiments. Any reference to elements in the singular, for example, using the articles “a,” “an,” “the,” or “said,” is not to be construed as limiting the element to the singular.

1. A method for operating an anti-theft alarm system for a vehicle, the vehicle including a sensor device for monitoring a vehicle interior of the vehicle, wherein the method comprises:
transmitting an electromagnetic output signal by the sensor device;
receiving an impulse response to the output signal by the sensor device, wherein the impulse response comprises a plurality of runtime components, wherein each runtime component is characteristic of a specific signal runtime;
comparing the impulse response with a reference impulse response and determining changes of the runtime components relative to the reference impulse response;
determining a change value as a function of the changes in at least a portion of the runtime components by aggregating the changes in at least a portion of the runtime components; and
activating an alarm when the change value reaches or exceeds a predetermined change reference value.

2. The method according to claim 1, wherein determining a change value comprises:
neglecting the runtime component within a predetermined signal runtime range, wherein the signal runtime range characterizes a close-up detection range of the sensor device.

3. The method according to claim 1, comprising:
determining a partial change value for a predetermined signal runtime range by aggregating the changes of the runtime components within the signal runtime range, wherein the signal runtime range characterizes a close-up detection range of the sensor device;
comparing the partial change value with a predetermined partial change limit value; and
adjusting the operation of the anti-theft alarm system as a function of the comparison result.

4. The method according to claim 3, wherein adjusting the operation of the anti-theft alarm system comprises:
adjusting the change reference value such that a sensitivity of the anti-theft alarm system is reduced when the partial change value reaches or exceeds the partial change limit value.

5. The method according to claim 3, wherein adjusting the operation of the anti-theft alarm system comprises:
neglecting at least a portion of the runtime components within the predetermined signal runtime range during the determination of the change value when the partial change value reaches or exceeds a predetermined partial change limit value.

6. The method according to claim 3, wherein adjusting the operation of the anti-theft alarm system comprises:
reducing a weighting of at least one runtime component within the predetermined signal runtime range during the determination of the change value when the partial change value reaches or exceeds a predetermined partial change limit value.

7. The method according to claim 1, wherein determining changes in the runtime component comprises:
filtering of the changes in the runtime components by a high-pass filter.

8. An anti-theft alarm system for a vehicle, the vehicle including a sensor device for monitoring a vehicle interior, wherein the anti-theft alarm system is configured to operate in accordance with the method of claim 1.

9. The anti-theft alarm system according to claim 8, wherein the sensor device is an ultra-wideband sensor.

10. The anti-theft alarm system according to claim 8, wherein the sensor device comprises a sensor device that is configured to transmit the electromagnetic output signal and to receive the impulse response to the output signal.

11. The anti-theft alarm system according to claim 8, wherein the sensor device is electromagnetically shielded in the direction of an external environment of the vehicle, at least in part, by at least one shielding element.

12. The anti-theft alarm system according to claim 8, comprising a computer program product comprising commands that cause the anti-theft alarm system to execute the method.

13. The anti-theft alarm system according to claim 12, comprising a computer-readable storage medium on which the computer program product is stored.
